(19) United States
(12) Patent Application Publication
(10) Pub. No.: US 2025/0245489 A1
(43) Pub. Date: Jul. 31, 2025

(54) PRE-FILTERING FOR AN ARTIFICIAL INTELLEGENCE PIPELINE

(71) Applicant: INTUIT INC., Mountain View, CA (US)

(72) Inventors: Natalie Bar ELIYAHU, Tel Aviv (IL); Ido Joseph FARHI, Tel Aviv (IL); Omer WOSNER, Tel Aviv (IL)

(73) Assignee: INTUIT INC., Mountain View, CA (US)

(21) Appl. No.: 18/426,226

(22) Filed: Jan. 29, 2024

(51) Int. Cl. G06N 3/0464; G06N 3/08

(52) U.S. Cl. CPC G06N 3/0464; G06N 3/08

(57) ABSTRACT

Systems and methods that pre-filter incoming data records for an artificial intelligence pipeline. The filtering is based on predictability: data records with a desired level of predictability are passed on to the pipeline while the remaining data records are filtered out. The level of predictability is determined by tokenizing the data records, retrieving a dictionary generated by training a neural network where the dictionary includes predictability scores of individual tokens, picking a maximum value for the tokens for each data record, and filtering out the data records with maximum values below a threshold. The computational efficiency of the artificial intelligence pipeline is significantly improved because the pipeline does not have to process data records with lower predictability.

### BACKGROUND

Artificial intelligence pipelines are widely used for predictions: for instance, these pipelines use a first type of information (e.g., transaction description) to predict a second type of information (e.g., vendor name). The prediction generally includes encoding both types of information and training a model with the encoded information. When new information is received, the new information is encoded and fed to the trained model to obtain the prediction. Both the encoding and use of the trained model require significant computing power.

However, not all incoming information has predictive value. In case of a vendor prediction, using the transaction description as an example, some transaction descriptions may contain keywords or other information that may be used to predict the corresponding vendor while other transaction information may be cryptic and just contain alphanumeric codes with little or no predictive value. When the information with little or no predictive value is processed by the artificial intelligence pipelines, there is a significant use of computational resources—for encoding and using the pipelines—with no concomitant benefits. This computationally inefficient situation is undesirable and a technical solution is needed.

### SUMMARY

Embodiments disclosed herein solve the aforementioned technical problems and may provide other solutions as well. The computational efficiency of artificial intelligence pipelines is increased by pre-filtering incoming data to remove the portion of the incoming data with little or no predictive value. In one or more embodiments, the pre-filtering uses a trained neural network (e.g., a convolutional neural network). In one or more embodiments, the neural network is trained using training data generated from known matches between transaction descriptions and vendor names. From the known matches, the transaction descriptions are tokenized and fed to the convolutional neural network that learns to predict the corresponding vendors. The trained convolutional neural network is used to construct a dictionary comprising the tokens and corresponding predictability scores. That is, the trained convolutional neural network will assign a prediction probability for each token, which is then stored in the dictionary as a predictability score. When a new transaction is received, the new transaction description is tokenized, and the predictability score of each token is retrieved from the dictionary. A maximum of the retrieved predictability scores is compared with a predetermined threshold. If the maximum is above the threshold, the transaction description has a desired predictive value and is passed on to the downstream artificial intelligence pipelines. If the maximum is below the threshold, the transaction description has less than the desired predictive value and is filtered out.

### BRIEF DESCRIPTION OF THE DRAWINGS

FIG. 1 shows a system configured to pre-filter transaction data for an artificial intelligence pipeline, based on the principles disclosed herein.

FIG. 2 is a block diagram of an example computing device implementing the described embodiments, based on the principles disclosed herein.

FIG. 3 shows a flowchart illustrating an example method of pre-filtering transaction data for an artificial intelligence pipeline, based on the principles disclosed herein.

FIG. 4 shows an example dataset of matched transactions used during the execution of the method shown in FIG. 3, based on the principles disclosed herein.

FIG. 5 shows an example token-vendor matrix generated during the execution of the method shown in FIG. 3, based on the principles disclosed herein.

FIG. 6 shows an example of an updated token vendor matrix generating during the execution of the method shown in FIG. 3, based on the principles disclosed herein.

FIG. 7 shows an example of normalized and sorted rows of the updated token-vendor matrix generated during the execution of the method shown in FIG. 3, based on the principles disclosed herein.

FIG. 8 shows an example of a convolutional neural network that is trained during the execution of the method shown in FIG. 3, based on the principles disclosed herein.

FIG. 9 shows an example portion of an example dictionary generated during the execution of the method shown in FIG. 3, based on the principles disclosed herein.

FIG. 10 shows an example filtering process performed during the execution of the method shown in FIG. 3, based on the principles disclosed herein.

It should be understood that the above figures are merely intended as examples to illustrate the different principles disclosed throughout this disclosure. The figures therefore present non-limiting embodiments.

### DETAILED DESCRIPTION OF SEVERAL EMBODIMENTS

Embodiments disclosed herein provide systems and methods that pre-filter incoming data records for an artificial intelligence pipeline. The filtering is based on predictability: data records with a desired level of predictability are passed on to the pipeline while the remaining data records are filtered out. The level of predictability is determined by tokenizing the data records, retrieving a dictionary generated by training a neural network, where the dictionary includes predictability scores of individual tokens, picking a maximum value for the tokens for each data record, and filtering out the data records with a maximum value below a threshold. The computational efficiency of the artificial intelligence pipeline is significantly improved because the pipeline does not have to process data records with lower predictabilities.

The description below describes transaction data and vendor names as illustrative examples, which are intended to describe one implementation of the different embodiments. That is, the embodiments disclose herein are equally applicable to any kind of data records.

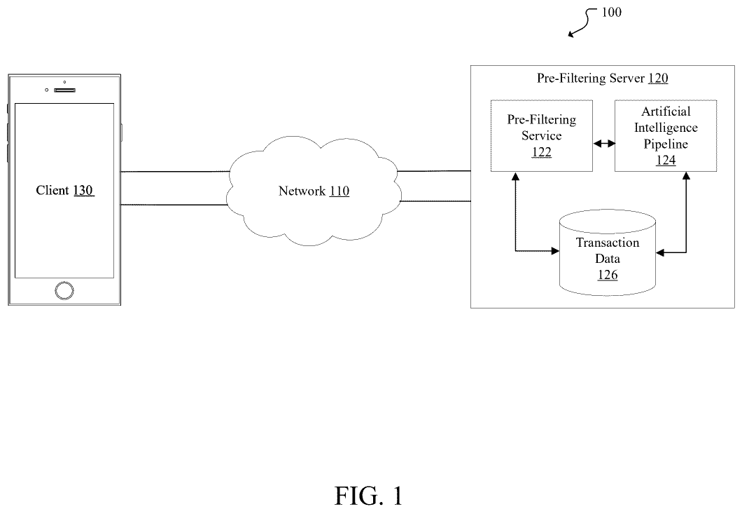

FIG. 1 shows a system 100 configured to pre-filter transaction data for an artificial intelligence pipeline, according to the principles disclosed herein. The system 100 includes a pre-filtering server 120 and at least one client 130. The pre-filtering server 120 and the client 130 communicate with one another through at least one network 110. The network 110 includes any kind of packet switching network, circuit switching network, or combinations thereof. For example, the network 110 may be the Internet and/or other public or private networks or combinations thereof. In one or more embodiments, the pre-filtering server 120 and the client 130 communicate with one another over secure channels (e.g., one or more of TLS/SSL channels).

In one or more embodiments, client 130 may be any device configured to provide access to remote applications, e.g., remote applications provided by the pre-filtering server 120. For example, the client 130 may include a smartphone, personal computer, tablet, laptop computer, and/or other type of device. A user, such as an administrator (admin) user may interact with the pre-filtering server 120, e.g., to access the pre-filtering service 122 using an interface of the client 130 and through the network 110. For example, the user may also provide instructions to the pre-filtering service 122 to pre-filter transaction data 126 for an artificial intelligence pipeline 124.

The pre-filtering server 120 comprises various hardware modules, software modules, and/or databases. As examples of these components include the pre-filtering service 122, artificial intelligence pipeline 124, and transaction data 126 of FIG. 1. The pre-filtering service 122 use the principles disclosed herein to access the transaction data 126 and pre-filter the transactions therein to be processed by the artificial intelligence pipeline 124. That is, the pre-filtering service 122 causes a portion of the transaction data 126 with desirable predictive values to be processed by the artificial intelligence pipeline 124, and causes another portion of the transaction data 126 with little or no predictive value to be filtered out. The artificial intelligence pipeline 124, which is configured to perform different types of predictive analyses on the transaction data 126, therefore becomes computationally efficient.

The pre-filtering server 120 and the client 130 are each depicted as single devices for ease of illustration, but those of ordinary skill in the art will appreciate that the pre-filtering server 120 and/or the client 130 may be embodied in different forms for different implementations. For example, the pre-filtering server 120 may include a plurality of devices or may be embodied in a single device or device cluster depending on embodiment. In another example, a plurality of clients 130 may be connected to network 110 and provide instructions to the pre-filtering server 120. A single user may have multiple clients 130, and/or there may be multiple users each having their own client(s) 130. Furthermore, as noted above, network 110 may be a single network or a combination of networks, which may or may not all use similar communication protocols and/or techniques.

Additionally, although the system 100 is shown as a client server model, this is only for illustration purposes and should not be consider limiting. For example, the pre-filtering server 120 may operate automatically without involving the client 130, or the client 130 itself may perform the operations of the pre-filtering server. In one or more embodiments, the operations of the system 100 may be performed within a peer-to-peer network.

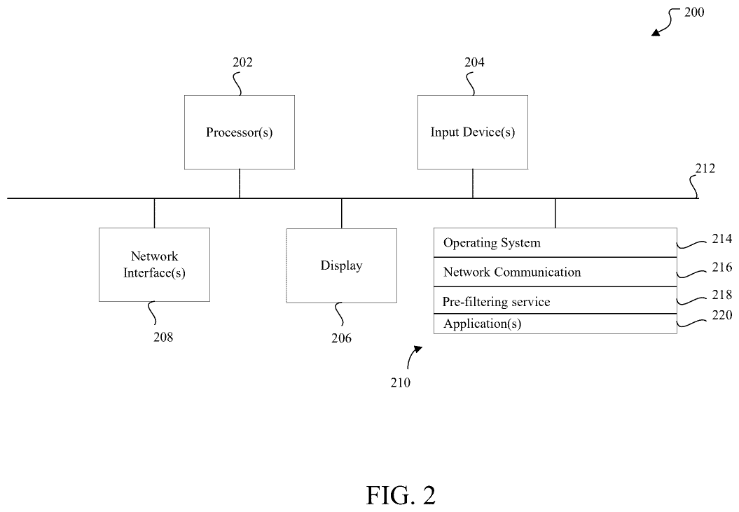

FIG. 2 is a block diagram of an example computing device 200 implementing the described embodiments, based on the principles disclosed herein. For example, the computing device 200 may form the pre-filtering server 120 or the client 130. The computing device 200 can be implemented on any electronic device that runs software applications derived from instructions, including without limitation personal computers, servers, smart phones, media players, electronic tablets, game consoles, email devices, etc. In one or more embodiments, the computing device 200 may include one or more processors 202, one or more input devices 204, one or more display devices 206, one or more network interfaces 208, and one or more computer-readable mediums 210. Each of these components may be coupled by bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from the input device 204; sending output to the display device 206; keeping track of files and directories on the computer-readable medium 210; controlling peripheral devices (e.g., disk drives, printers, etc.) which can be controlled directly or through an I/O controller; and managing traffic on the bus 212. Network communications instructions 216 may establish and maintain network connections (e.g., software for implementing communication protocols, such as TCP/IP, HTTP, Ethernet, telephony, etc.).

Pre-filtering service 218 is implemented at least in part by instructions stored in the memory 210 to provide the pre-filtering service 122 functionality described throughout this disclosure. Application(s) 220 may be an application that uses or implements the processes described herein and/or other processes. The processes may also be implemented in operating system 214.

The described features may be implemented in one or more computer programs (e.g., computer programs forming the pre-filtering service 218) that may be executable on a programmable system including at least one programmable processor (e.g., processor 202) coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors (e.g., processor 202) for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories (e.g., computer readable medium 210) for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

One or more features or steps of the disclosed embodiments may be implemented using an API. An API may define one or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

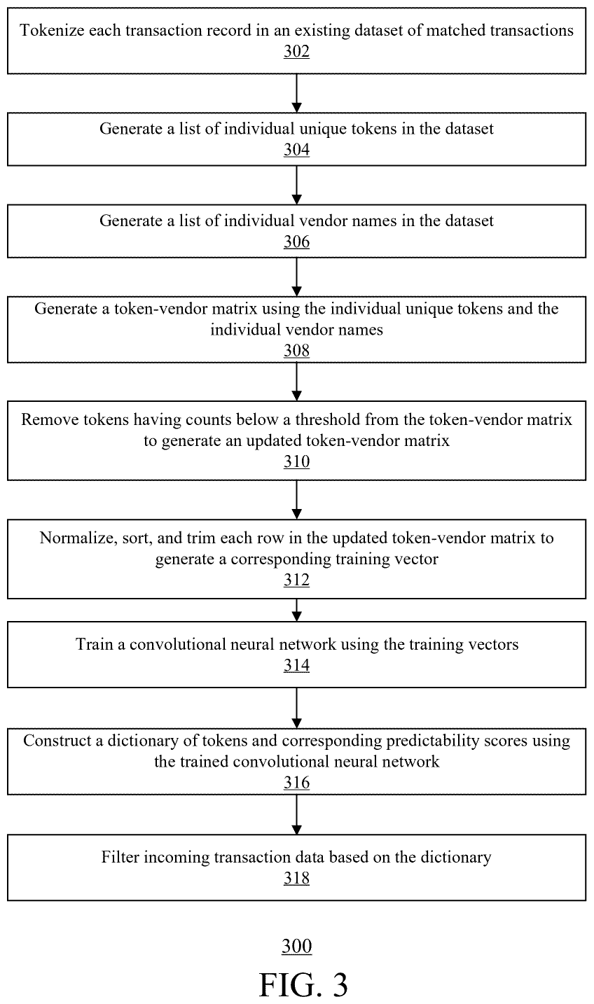

FIG. 3 shows a flowchart illustrating an example method 300 of pre-filtering transaction data for an artificial intelligence pipeline, based on the principles disclosed herein. The steps of the method 300 may be performed by any type of computing device (e.g., pre-filtering server 120). It should further be understood that the steps shown in FIG. 3 and described herein are mere examples and methods with additional, alternate, and fewer number of steps should also be considered within the scope of this disclosure.

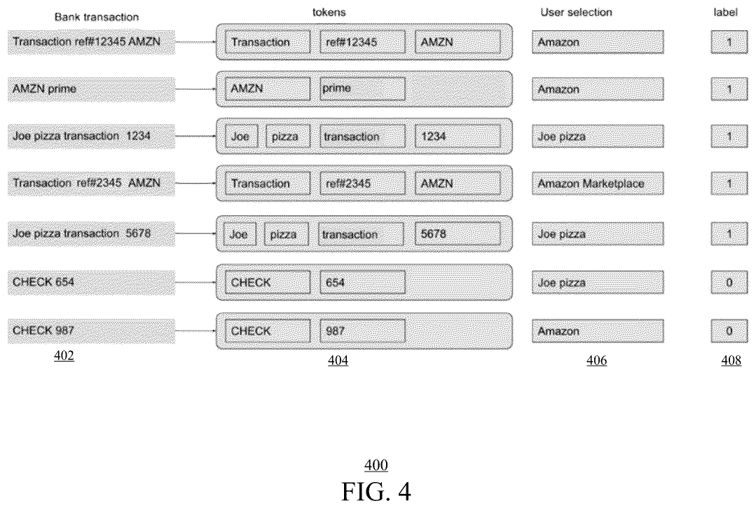

The method 300 begins at step 302 where each transaction in an existing dataset of matched transactions is tokenized. For example, FIG. 4 shows an example dataset 400 of matched transactions used during the execution of step 302, based on the principles disclosed herein. As shown, the dataset 400 comprises a list of transactions 402 matched to a list of vendors 406. In the illustrated example, a transaction 402 “Transaction ref #12345 AMZN” is matched to vendor 406 “Amazon,” another transaction 402 “Joe pizza transaction 1234” is matched to another vendor 406 “Joe pizza,” etc. For the list of the transactions 402 matched to the vendors 406, corresponding tokens 404 are generated. For example, tokens 404 “Transaction,” “ref #12345,” and “AMZN” are generated for the transaction 402 “Transaction ref #12345 AMZN”, tokens 404 “Joe,” “pizza,” and “transaction” are generated for the transaction 402 “Joe pizza transaction 1234,” and so on.

The illustrated dataset 400 further includes a manual label 408. The manual label 408 is “1” if the top n vendors for the tokens 404 are similar or refer to the same real company. An example for label “1” could be: “amazon,” “amazom,” “AWS,” “amazon market place,” “clouds,” “amzoon,” etc. Label “0” can be used for heterogenous (i.e., non-similar vendors). For example, tokens 404 “CHECK” and “654” are matched to vendor 406 “Joe pizza” and similar tokens 404 “CHECK” and “987” are matched to vendor 406 “Amazon,” and therefore have a manual label 408 of “0” because the vendors are different. It should, however, be understood that the manual label 408, which may be performed by the admin user, is optional and may not necessarily used by the steps below.

Returning to FIG. 3, at step 304, a list of individual unique tokens in the dataset are generated. For example, the list of individual unique tokens 404 in the dataset 400 are:
“transaction”
“ref #12345”
“AMZN”
“prime”
“joe”
“pizza”
“1234”
“ref #2345”
“5678”
“CHECK”
“654”
“987”
   Here, the example tokens are space delimited—that is, the tokens 404 are separated by (and therefore generated based on) the spaces within the list of transactions 402. The space delimitation, however, is just an example and should not be considered limiting. The tokens may be, for example, less than whole words (i.e., not whole words) between the spaces, but subsets of characters within those words.

At step 306, a list of individual vendor names in the dataset may be generated. Continuing with the example dataset 400, the individual vendor names include:
“Amazon”
“Amazon marketplace”
“Joe pizza”

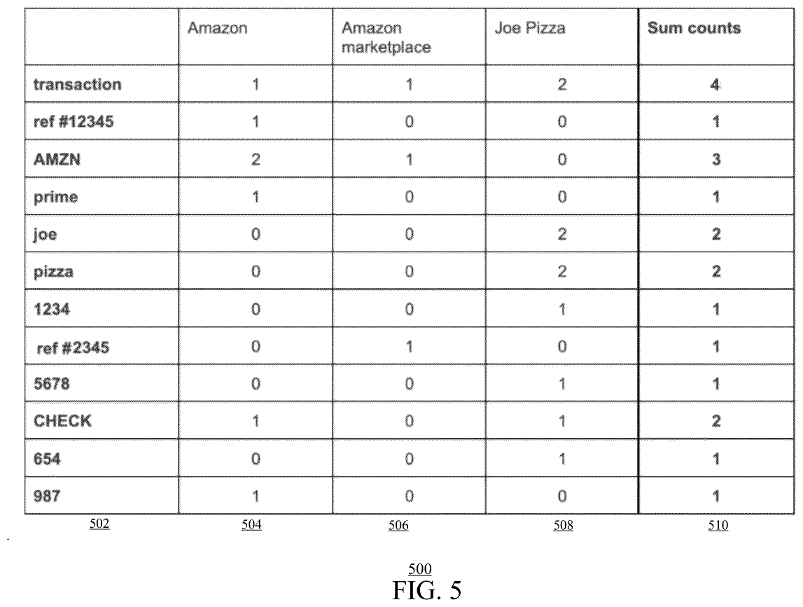

At step 308, a token-vendor matrix may be generated using the individual tokens and the individual vendor names. FIG. 5 shows an example token-vendor matrix 500 generated during the execution of step 308, based on the principles disclosed herein. The token-vendor matrix 500 shows the total counts of the matches within the dataset 400. As shown, first column 502 shows the list of tokens (i.e., tokens 404 shown in FIG. 4), second column 504 shows the number of matches of the list of tokens with vendor “Amazon,” third column 506 shows the number of matches of the list of tokens with vendor “Amazon marketplace,” fourth column 508 shows the number of matches of the list of tokens 404 with vendor “Joe Pizza,” and fifth column 510 shows the sum of the matches for each of the tokens. In other words, a cell (i, j) within the token vendor-matrix 500, except for cells in the fifth column 510 providing the sums of the rows, represents the number of transactions having a token i in their description and matched to vendor j.

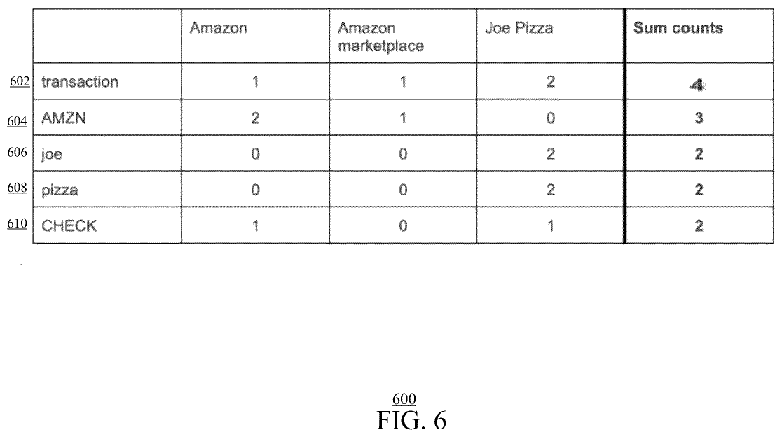

Turning back to FIG. 3, at step 310, tokens having counts below a threshold are removed from the token-vendor matrix to generate an updated token-vendor matrix. FIG. 6 shows an updated token vendor matrix 600 generated during the execution of the step 310 where the tokens having less than two counts have been removed, based on the principles disclosed herein. The removed tokens may not have the requisite predictive value and may generate unnecessary noise. After their removal, only the following tokens remain in the illustrated example:
transaction (row 602) with count 4
AMZN (row 604) with count 3
joe (row 606) with count 2
pizza (row 608) with count 2
CHECK (row 610) with count 2

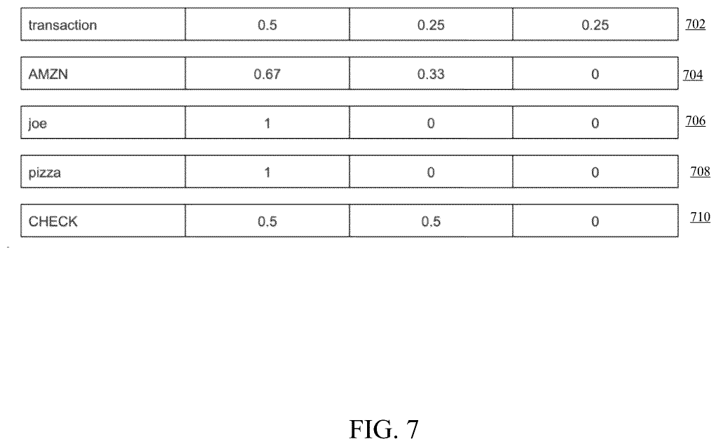

Turning back to FIG. 3, at step 312, each row in the updated token-vendor matrix may be normalized, sorted, and trimmed to generate a corresponding training vector. FIG. 7 shows normalized and sorted rows of the updated token-vendor matrix (e.g., token-vendor matrix 600 shown in FIG. 6) generated during the execution of step 312, based on the principles disclosed herein. It should be noted that the order of the entries in the rows of the token-vendor matrix 600 in FIG. 6 is different from the order of the entries in the rows of FIG. 7 because of the sorting. As shown, the first normalized and sorted row 702 for the token “transaction” comprises the values {2/4=0.5, 1/4=0.25, 1/4=0.25}, second normalized and sorted row 704 for the token “AMZN” comprise the values {2/3=0.67, 1/3=0.33, 0/3=0}, third normalized and sorted row 706 for the token “joe” comprises the values {2/2=1, 0/2=0, 0/2=0}, fourth normalized and sorted row 708 for the token “pizza” comprises the values {2/2=1, 0/2=0, 0/2=0}, and fifth normalized and sorted row 710 for the token “CHECK” comprises the values {1/2=0.5, 1/2=0.5, 0/2=0}. The trimming includes taking a predetermined number of top values from each of the normalized and sorted rows (e.g., rows 702, 704, 706, 708, 710). For example, a row may have a plurality of values, and top 128 values of the plurality of values may be taken to be used as a training vector for step 314.

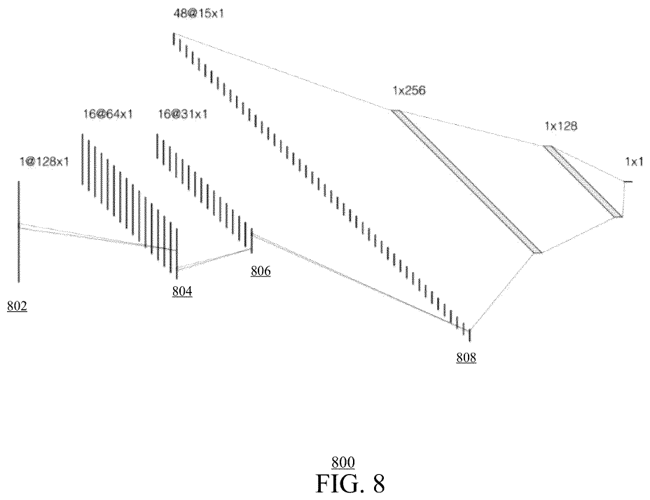

Turning back to FIG. 3, at step 314, a convolutional neural network is trained using the training vectors generated at step 312. FIG. 8 shows an example convolutional neural network 800 that is trained using the training vectors during the execution of the step 314, based on the principles disclosed herein. As shown, the convolutional neural network 800 has a convolutional layer 802 that takes in a training vector of 128 values, from which a max pooling layer 804 generates 16 vectors of 64 values each. Another convolutional layer 806 reduces the 64 values to corresponding 31 values, from which another max pooling layer 808 generates 48 vectors of 15 values each. Multiple iterations of convolutional layers and max pooling layers are applied until the convolutional neural network 800 converges on a solution. The solution is the prediction probability of the entered vector, which is used to determine whether the vector can be used for prediction. Step 314 may further include, validating the model accuracy of the convolutional neural network 800 on a validation set, evaluating a final accuracy on a test set, and tweaking the convolutional neural network 800 as necessary to achieve optimal results, all of which are known in the art and therefore not described herein in detail. The predictable/unpredictable threshold (to be applied to the generated prediction probability) may be chosen based on optimal precision desired for a specific use case.

Furthermore, it should be understood that the specific layers 802, 804, 806, 808, and the specific vectors sizes at these layers, of the conventional neural network 800 are merely intended as illustrative examples and should not be considered limiting. That is, alternate neural networks, machine learning models, and/or analytical models with alternate types and number of layers, alternate vector sizes, etc. should also be considered within the scope of this disclosure. Additionally, the convolutional neural network 800 can be retrained with new data, as needed.

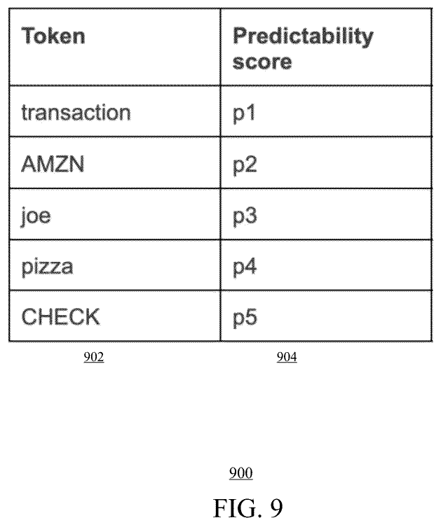

Turning to FIG. 3, at step 316, a dictionary of tokens and corresponding predictability scores is constructed using the trained convolutional neural network (e.g., convolutional neural network 800 shown in FIG. 8). For example, the predictability scores may be the probabilities of predictions learned by the convolutional neural network during the training. Alternatively, additional tokens may be fed to the conventional neural network, which then generates a predictability score for the token. In one or more embodiments, the predictability score is a probability between 0 and 1. FIG. 9 shows a portion of an example dictionary 900 with tokens and corresponding predictability scores generated during the execution of step 316, based on the principles disclosed herein. Particularly, first column 902 includes tokens and second column 904 includes the corresponding predictability scores. Therefore, correspondence between the tokens and the predictability scores of the illustrated example is as follows: “transaction”→p1, “AMZN”→p2, “joe”→p3, “pizza”→p4, “CHECK”→p5.

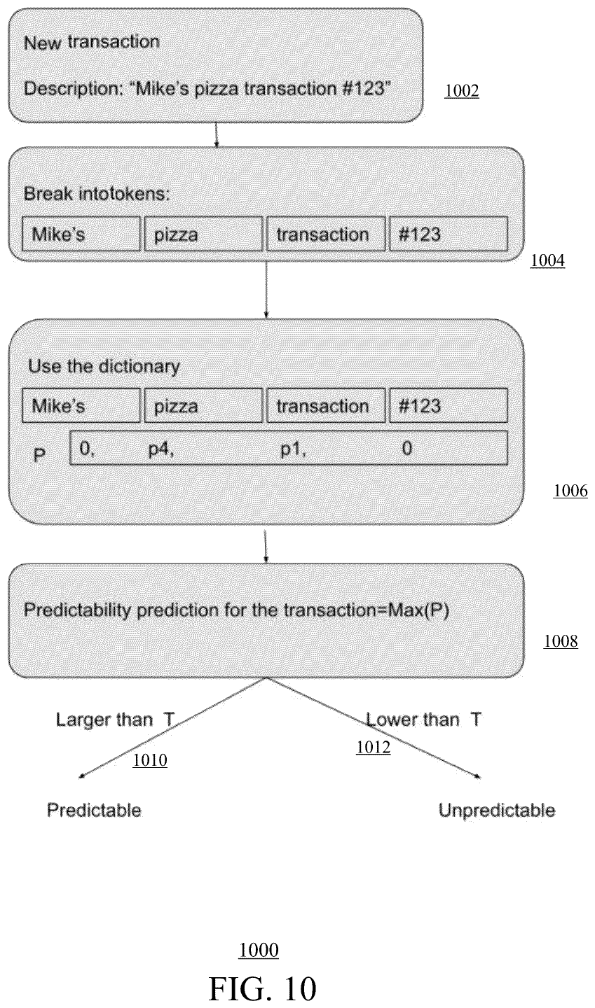

Turning back to FIG. 3, at step 318, incoming transaction data is filtered based on the dictionary. The filtering is used to determine whether the incoming transaction data should be used for other downstream artificial intelligence pipelines. Particularly, the filtering step 318 determines whether the incoming transaction data is predictable enough for the downstream artificial intelligence pipelines. FIG. 10 shows an example filtering process 1000 performed during the execution of step 318, based on the principles disclosed herein. At step 1002, a new transaction with a corresponding description is received. In the shown example, the description for the new transaction is “Mike's pizza transaction #123.” At step 1004, the description is broken into tokens, e.g., by using space delimitation. The generated tokens include: “Mike's,” “pizza,” “transaction”, and “#123.” At step 1006, the predictability scores are retrieved from the dictionary. Should there be no entry in the dictionary, the prediction score is set to 0, e.g., for the tokens “Mike's” and “#123.” For the remaining tokens, “pizza” and “transaction,” the prediction scores are p4 and p1, respectively. At step 1008, the maximum predictability score of all the tokens is taken and compared to a threshold (T). If the maximum predictability score is larger than the threshold, the transaction is determined to be predictable at step 1010. On the other hand, if the maximum predictability score is lower than the threshold, the transaction is determined to be unpredictable at step 1012. The unpredictable transaction is not used for the downstream artificial intelligence pipeline, thereby increasing computational efficiency.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method performed by a processor, said method comprising:
tokenizing received transaction data to generate a plurality of tokens;
for the plurality of tokens, retrieving corresponding dictionary entries of predictability scores generated by a trained neural network, the neural network being trained on a labeled dataset with training tokens matched to corresponding vendors, the dictionary entries being generated based on prediction probabilities of the training tokens generated by the trained neural network;
calculating a maximum predictability score of the retrieved predictability scores;
providing the transaction data for downstream processing in response to determining that the maximum predictability score is above a threshold; and
filtering out the transaction data in response to determining that the maximum predictability score is below the threshold.

2. The method of claim 1, the tokenizing the received transaction data further comprising:
receiving the transaction data comprising a transaction description; and
tokenizing the transaction description to generate the plurality of tokens.

3. The method of claim 1, the tokenizing the received transaction data further comprising:
receiving the transaction data comprising a transaction description; and
tokenizing the transaction description based on spaces within the transaction description to generate the plurality of tokens.

4. The method of claim 1, the providing the transaction data for downstream processing comprises:
providing the transaction data to an artificial intelligence pipeline.

5. The method of claim 1, the retrieving the corresponding dictionary entries comprising:
retrieving the corresponding dictionary entries of the predictability scores generated by a trained convolutional neural network.

6. The method of claim 1, further comprising:
assigning a predictability score of zero to a token that does not have a corresponding dictionary entry.

7. The method of claim 1, the training of the neural network comprising:
generating a token-vendor matrix from the labeled dataset, the token-vendor matrix indicating counts of matches between tokens and corresponding vendors;
generating an updated token-vendor matrix by removing tokens with counts lower than a predetermined count threshold; and
selecting the training tokens from the updated token-vendor matrix.

8. The method of claim 7, the selecting the training tokens comprising:
normalizing the counts of matches in the updated token-vendor matrix; and
selecting the training tokens and corresponding normalized counts of matches in the updated token-vendor matrix.

9. The method of claim 7, the selecting the training tokens comprising:
normalizing the counts of matches in the updated token-vendor matrix;
sorting the normalized counts of matches;
removing the normalized counts of matches below a predetermined normalized counts of matches threshold; and
selecting the training tokens and corresponding normalized counts above the predetermined normalized counts of matches threshold.

10. The method of claim 1, further comprising:
retraining the neural network with a new labeled dataset.

11. A system comprising:
a non-transitory storage medium storing computer program instructions; and
a processor configured to execute the computer program instructions to cause operations comprising:
tokenizing received transaction data to generate a plurality of tokens;
for the plurality of tokens, retrieving corresponding dictionary entries of predictability scores generated by a trained neural network, the neural network being trained on a labeled dataset with training tokens matched to corresponding vendors, the dictionary entries being generated based on prediction probabilities of the training tokens generated by the trained neural network;
calculating a maximum predictability score of the retrieved predictability scores;
providing the transaction data for downstream processing in response to determining that the maximum predictability score is above a threshold; and
filtering out the transaction data in response to determining that the maximum predictability score is below the threshold.

12. The system of claim 11, the tokenizing the received transaction data further comprising:
receiving the transaction data comprising a transaction description; and
tokenizing the transaction description to generate the plurality of tokens.

13. The system of claim 11, the tokenizing the received transaction data further comprising:
receiving the transaction data comprising a transaction description; and
tokenizing the transaction description based on spaces within the transaction description to generate the plurality of tokens.

14. The system of claim 11, the providing the transaction data for downstream processing comprises:
providing the transaction data to an artificial intelligence pipeline.

15. The system of claim 11, the retrieving the corresponding dictionary entries comprising:
retrieving the corresponding dictionary entries of the predictability scores generated by a trained convolutional neural network.

16. The system of claim 11, the operations further comprising:
assigning a predictability score of zero to a token that does not have a corresponding dictionary entry.

17. The system of claim 11, the training of the neural network comprising:
generating a token-vendor matrix from the labeled dataset, the token-vendor matrix indicating counts of matches between tokens and corresponding vendors;
generating an updated token-vendor matrix by removing tokens with counts lower than a predetermined count threshold; and
selecting the training tokens from the updated token-vendor matrix.

18. The system of claim 17, the selecting the training tokens comprising:
normalizing the counts of matches in the updated token-vendor matrix; and
selecting the training tokens and corresponding normalized counts of matches in the updated token-vendor matrix.

19. The system of claim 17, the selecting the training tokens comprising:
normalizing the counts of matches in the updated token-vendor matrix;
sorting the normalized counts of matches;
removing the normalized counts of matches below a predetermined normalized counts of matches threshold; and
selecting the training tokens and corresponding normalized counts above the predetermined normalized counts of matches threshold.

20. The system of claim 11, the operations further comprising:
retraining the neural network with a new labeled dataset.
